(19) United States
(12) Patent Application Publication
(10) Pub. No.: US 2022/0303324 A1
(43) Pub. Date: Sep. 22, 2022

(54) METHOD AND SYSTEM FOR MULTI-SERVICE PROCESSING

(71) Applicant: BEIJING DAJIA INTERNET INFORMAITON TECHNOLOGY CO., LTD., Beijing (CN)

(72) Inventors: Haowen ZHANG, Beijing (CN); Peiqiang TAN, Beijing (CN); Weibo LI, Beijing (CN); Qun WANG, Beijing (CN)

(21) Appl. No.: 17/514,519

(22) Filed: Oct. 29, 2021

(30) Foreign Application Priority Data
Mar. 16, 2021 (CN) 202110281376.4

(51) Int. Cl. H04L 29/06; G06F 9/48

(52) U.S. Cl. CPC H04L 65/4069; G06F 9/4843

(57) ABSTRACT

The disclosure can provide a method for multi-service processing. The method includes: obtaining a target identifier of a target live streaming room; querying task data of a current task corresponding to the target live streaming room based on the target identifier; monitoring a task state of the current task in response to the queried task data; determining a first service identifier of a first service corresponding to a current time point based on preset service mapping information in response to the monitored task state being a task-ended state, the preset service mapping information representing mapping relationship between multiple services and preset service running durations; and sending task prompt information corresponding to the first service to a terminal corresponding to the target live streaming room based on the first service identifier, to make the terminal display the task prompt information in the target live streaming room.

### CROSS-REFERENCE TO RELATED APPLICATION

The disclosure claims priority to Chinese Patent Application No. 202110281376.4 filed on Mar. 16, 2021, the content of which is hereby incorporated by reference into this disclosure.

### FIELD

The disclosure relates to the field of multi-service processing techniques, and more particularly, to a method, a system, an electronic device and a storage medium for multi-service processing.

### BACKGROUND

In some Internet platforms, in order to increase the amount of visits on the platform and enrich the content of the platform, some services are often developed. In the related art, considering that different services often require different resources to perform corresponding tasks, it is common to run a new service after the current service is completely offline.

### SUMMARY

According to embodiments of the disclosure, a method for multi-service processing is provided. The method includes: obtaining a target identifier of a target live streaming room; querying task data of a current task corresponding to the target live streaming room based on the target identifier; monitoring a task state of the current task in response to the queried task data; determining a first service identifier of a first service corresponding to a current time point based on preset service mapping information in response to the monitored task state being a task-ended state, the preset service mapping information representing mapping relationship between multiple services and preset service running durations; and sending task prompt information corresponding to the first service to a terminal corresponding to the target live streaming room based on the first service identifier, to make the terminal display the task prompt information in the target live streaming room.

According to embodiments of the disclosure, a multi-service processing system is provided. The system includes: a service processing server and a terminal.

The service processing server is configured to: obtain a target identifier of a target live streaming room; query task data of a current task corresponding to the target live streaming room based on the target identifier; monitor a task state of the current task in response to the queried task data; determine a first service identifier of a first service corresponding to a current time point based on preset service mapping information in response to the monitored task state being a task-ended state, the preset service mapping information representing mapping relationship between multiple services and preset service running durations; and send task prompt information corresponding to the first service to the terminal corresponding to the target live streaming room based on the first service identifier.

The terminal is configured to display the task prompt information in the target live streaming room.

According to embodiments of the disclosure, an electronic device is provided. The electronic device includes a processor; and a memory for storing instructions executable by the processor. The processor is configured to execute the instructions to perform any method in the first aspect.

According to embodiments of the disclosure, a computer-readable storage medium is provided. When instructions in the storage medium are executed by a processor of an electronic device, the electronic device is caused to perform any method in the first aspect.

It is to be understood that both the foregoing general description and the following detailed description are exemplary and explanatory only and are not restrictive of the disclosure.

### BRIEF DESCRIPTION OF THE DRAWINGS

The drawings, which are incorporated in and constitute a part of this specification, illustrate embodiments consistent with the disclosure and, together with the description, serve to explain the principles of the disclosure, but may not constitute an improper limitation of the disclosure.

FIG. 1 is a schematic diagram illustrating an application environment according to some embodiments of the disclosure.

FIG. 2 is a flowchart of a method for multi-service processing according to some embodiments of the disclosure.

FIG. 3 is a flowchart of a method for multi-service processing according to some embodiments of the disclosure.

FIG. 4 is a flowchart of monitoring the task state of the current task by the service processing server according to some embodiments of the disclosure.

FIG. 5 is a flowchart of monitoring the task state of the current task by the service processing server according to some embodiments of the disclosure.

FIG. 6 is a schematic diagram illustrating a terminal page displaying task prompt information according to some embodiments of the disclosure.

FIG. 7 is a flowchart of a method for multi-service processing according to some embodiments of the disclosure.

FIG. 8 is a block diagram illustrating an apparatus for multi-service processing according to some embodiments of the disclosure.

FIG. 9 is a schematic diagram illustrating an electronic device for multi-service processing according to some embodiments of the disclosure.

### DETAILED DESCRIPTION

To enable those skilled in the art to better understand the technical solutions of the disclosure, the technical solutions in embodiments of the disclosure will be described clearly and completely with reference to the drawings.

It should be noted that the terms such as “first” and “second” in the specification and claims and the drawings of the disclosure are used to distinguish similar objects, and not necessarily used to describe a specific order or sequence. It should be understood that the data used in this way may be interchanged with each other under appropriate circumstances so that the embodiments of the disclosure described herein may be implemented in a sequence other than those illustrated or described herein. The implementation manners described in the following embodiments do not represent all implementation manners consistent with the disclosure. Rather, they are merely examples of apparatuses and methods consistent with some aspects of the disclosure as detailed in the appended claims.

It should be noted that user information (including but not limited to user equipment information, user personal information, etc.) and data (including but not limited to data for displaying, data for analyzing, etc.) involved in the disclosure has been authorized by the user or fully authorized by all parties.

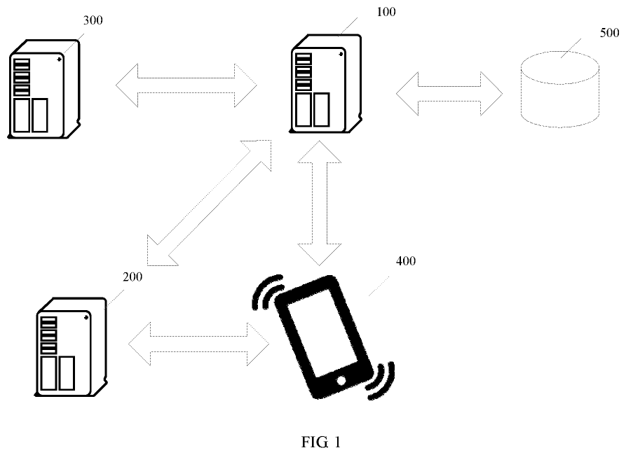

With reference to FIG. 1, FIG. 1 is a schematic diagram illustrating an application environment according to some embodiments of the disclosure. As illustrated in FIG. 1, the application environment may include a service processing server 100, a resource distribution server 200, a live streaming server 300, a terminal 400, and a storage device 500.

In some embodiments, the service processing server 100 may perform multi-service processing and deliver task prompt information to the terminal 400, so that the terminal 400 executes a task corresponding to a service based on the task prompt information. The resource distribution server 200 may perform virtual resource distribution based on the information of task execution result corresponding to the service. The live streaming server 300 may determine, for the service processing server 100, a delivery target (live streaming room) of the task prompt information in a service processing process based on actual application requirements.

In some embodiments, the terminal 400 may provide business-related services to a user, and the terminal 400 may display the task prompt information to a corresponding service object. In some embodiments, the terminal 400 may include an audience terminal in a live streaming scene, and may also be an anchor terminal in a live streaming scene.

In some embodiments, the storage device 500 may store task data of tasks corresponding to a service.

In some embodiments, the aforementioned servers, i.e., the service processing server 100, the resource distribution server 200, and the live streaming server 300, may be independent physical servers, a server cluster, a distributed system composed of multiple physical servers, or cloud servers that may provide basic cloud computing services such as cloud services, cloud databases, cloud computing, cloud functions, cloud storage, network services, cloud communications, middleware services, domain name services, security services, CDN (content delivery network), and big data and artificial intelligence platforms.

In some embodiments, the foregoing terminal 400 may include, but is not limited to, an electronic device such as a smart phone, a desktop computer, a tablet computer, a notebook computer, a smart speaker, a digital assistant, an augmented reality (AR)/virtual reality (VR) device, a smart wearable device. In some embodiments, an operating system running on the electronic device may include, but is not limited to, Android system, IOS system, Linux, Windows, and the like.

In some embodiments, the storage device 500 may be a database or a cache.

In addition, it should be noted that what is illustrated in FIG. 1 is one application environment provided by the disclosure. In actual applications, other application environments may also be included. For example, the service processing server 100, the resource distribution server 200, and the live streaming server 300 mentioned above may be one server. In some embodiments, the above service functions of the service processing server 100, the resource distribution server 200, and the live streaming server 300 may be integrated on one server.

In some embodiments of the disclosure, the service processing server 100, the resource distribution server 200, the live streaming server 300, the terminal 400, and the storage device 500 may be directly or indirectly coupled through wired or wireless communication, which is not limited in this disclosure.

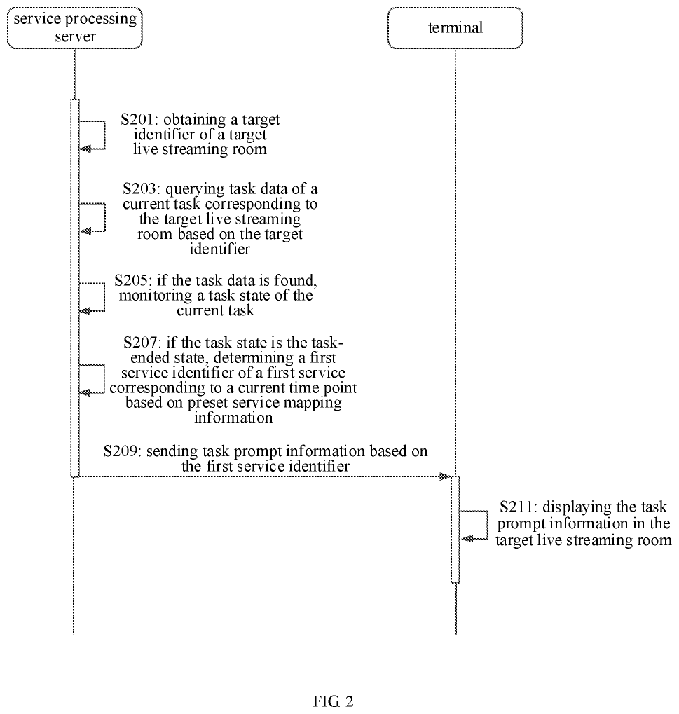

FIG. 2 is a flowchart of a method for multi-service processing according to some embodiments of the disclosure. As illustrated in FIG. 2, the method for multi-service processing may include the following.

In S201, a service processing server obtains a target identifier of a target live streaming room.

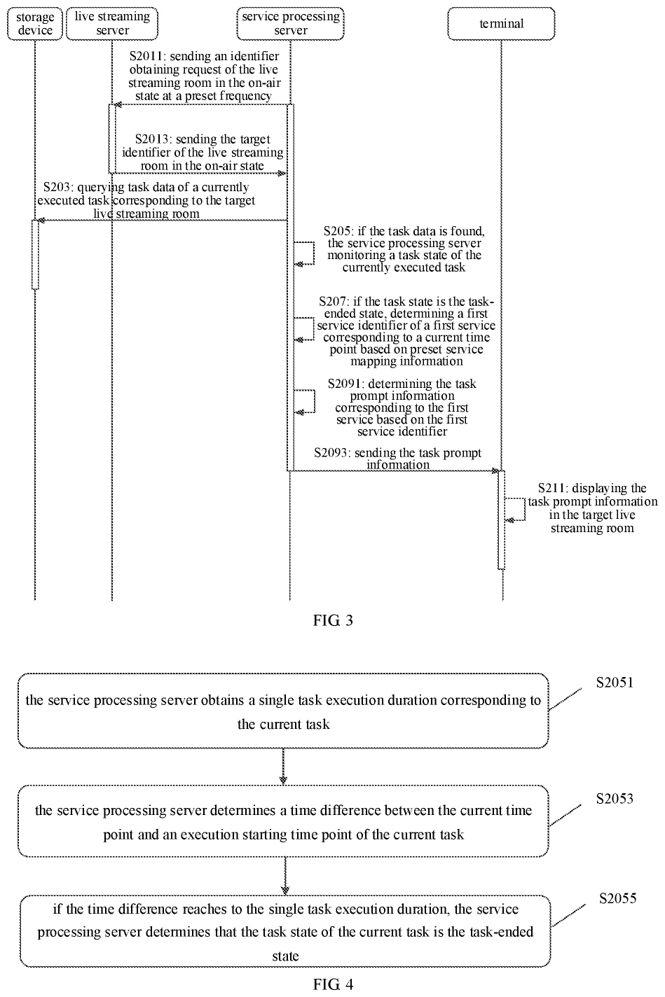

In some embodiments of the disclosure, the target live streaming room may be a delivery target of task prompt information. The delivery target of task prompt information varies according actual application scenario. In some embodiments, for example, in a live streaming scenario, the target live streaming room may include a live streaming room in an on-air state. Correspondingly, as illustrated in FIG. 3, that the service processing server obtains the target identifier of the target live streaming room may include the following.

In S2011, the service processing server sends an identifier obtaining request of the live streaming room in the on-air state to a live streaming server at a preset frequency.

In S2013, the live streaming server sends the target identifier of the live streaming room in the on-air state to the service processing server.

In some embodiments, the preset frequency may be preset according to the requirements for timeliness in practical applications. For example, the service processing server can send the identifier obtaining request every 3 seconds. In some embodiments, the live streaming server may update identifiers of live streaming rooms in the on-air state in real time according to whether the respective live streaming rooms are in the on-air state. Or, the live streaming server may determine the identifier of the live streaming room in the on-air state according to whether the respective live streaming rooms are in the on-air state after receiving the identifier obtaining request. Correspondingly, the aforementioned target identifier may include an identifier of a live streaming room in an on-air state. In some embodiments, the identifier may be account information corresponding to an anchor terminal.

In the above embodiments, the target identifier of the live streaming room in the on-air state is obtained from the live streaming server according to the preset frequency, which can facilitate timely update of the delivery target of the task prompt information, thereby providing data support for subsequent service processing.

In S203, the service processing server queries task data of a current task corresponding to the target live streaming room based on the target identifier.

In some embodiments, as illustrated in FIG. 3, the above-mentioned action that service processing server queries the task data of the current task corresponding to the target live streaming room based on the target identifier may include the following. The service processing server queries the task data of the current task corresponding to the target live streaming room based on the target identifier from the storage device.

In some embodiments, the task data of the task being executed, i.e., the current task, may be stored in the storage device. The task may vary according to a service to which the task belongs in actual applications. In some embodiments, one or more tasks may be set for the same service. In some embodiments, taking the above live streaming scenario as an example, a certain service is a Spring Festival event, and a task corresponding to the Spring Festival event is that the audience terminals of the live streaming room presents a blessing (virtual item) to the anchor terminal.

In some embodiments, the task data may include a service identifier of a service to which the corresponding task belongs. In some embodiments of the disclosure, service running durations (hereinafter referred to as preset service running durations) may be preset for different services respectively. Correspondingly, an execution starting time point of a task corresponding to the service is within a preset service running execution of the service.

In the above embodiments, by storing the task data of the current task corresponding to each target live streaming room in the storage device, it facilitates the timely query of the task data.

In S205, if the task data is found, the service processing server monitors a task state of the current task.

In practical applications, based on the above live streaming scenario, for example, the target live streaming room is a live streaming room in an on-air state. The live streaming room in the on-air state may include a live streaming room that just starts a live streaming and a live streaming room that has provided a live streaming for a period of time.

In some embodiments, for a live streaming room that has provided a live streaming for a period of time, the storage device stores task data of a current task, and correspondingly, the corresponding task data can be found. For a live streaming room that has just started a live streaming, task data of a current task is not stored in the storage device, and correspondingly, the corresponding task data cannot be found.

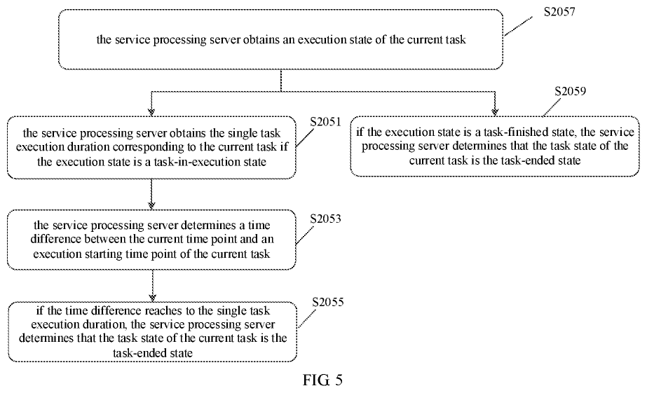

In some embodiments, if the task data is found, that is, the target live streaming room has a current task, and the service processing server may determine the task state of the current task. In some embodiments, the task state of the currently executing task may indicate whether the current task is ended. In detail, the task state may include a task-ended state and a task-not-ended state. In some embodiments, that a task state of a task is the task-ended state may include that a task execution duration of the task reaches a preset single task execution duration, and/or the task execution is finished. In some embodiments, if the task data is found, and the task execution duration of the task does not reach the preset single task execution duration, and the task execution is not finished, it may be determined that the task state of the task is a task-not-ended state. In some embodiments, as illustrated in FIG. 4, the action that the service processing server monitors the task state of the current task may include the following.

In S2051, the service processing server obtains a single task execution duration corresponding to the current task.

In S2053, the service processing server determines a time difference between the current time point and an execution starting time point of the current task.

In S2055, if the time difference reaches to the single task execution duration, the service processing server determines that the task state of the current task is the task-ended state.

In some embodiments, a corresponding single task execution duration may be preset for each service. For example, in a case where one service corresponds to multiple tasks, a single task execution duration may be separately set for each of multiple tasks corresponding to one service. The corresponding execution time of a single task.

In some embodiments, if the task state is identified based on whether the task execution duration of the task reaches the preset single task execution duration, the time difference between the current time point and the execution starting time point, i.e., an actual execution duration of the task, can be calculated, and it is monitored in real time whether the time difference reaches the single task execution duration. If the time difference reaches the single task execution duration, the task state of the task may be determined as the task-ended state.

In the above embodiments, based on the actual execution duration of the task and the single task execution duration, it may be determined in time that the task is in the task-ended state when the actual execution duration reaches the single task execution duration, and then service switching may be performed in time based on the current time point.

In some embodiments, as illustrated in FIG. 5, before the service processing server obtains the single task execution duration corresponding to the current task, monitoring the task state of the current task, the above action that the service processing server monitors the task state of the current task may include the following.

In S2057, the service processing server obtains an execution state of the current task.

Correspondingly, the action in S2051 may include that the service processing server obtains the single task execution duration corresponding to the current task if the execution state is a task-in-execution state.

In some embodiments, the execution state of the current task may be obtained before identification of the task state is performed based on the actual execution duration of the task in combination with the single task execution duration. In detail, the execution state may indicate whether the task is completed. In detail, the execution state may include a task-in-execution state and a task-finished state. In detail, whether the execution state of the task is the task-in-execution state or the task-finished state may be determined based on a specific task completion condition. In some embodiments, in the above-mentioned Spring Festival event scenario, the task corresponding to the Spring Festival event is that the audience in the live streaming room presents blessings to the anchor. A completion condition of the task is that the number of blessings received by the anchor reaches a preset number threshold. The preset number threshold may be preset according to actual application. Correspondingly, the execution state may be determined based on whether the number of blessings received by the anchor reaches the preset number threshold. In detail, if the number of the received blessings reaches the preset number threshold, the execution state may be determined as the task-completed state. Otherwise, if the number of the received blessings does not reach the preset number threshold, the execution state may be determined as a task-in-execution state.

In some embodiments, when the execution state is the task-in-execution state, whether the task state is the task-ended state may be identified based on the actual execution duration of the task and the single task execution duration.

In some embodiments, as illustrated in FIG. 5, the action that the service processing server monitors the task state of the current task may include the following.

In S2059, if the execution state is a task-finished state, the service processing server determines that the task state of the current task is the task-ended state.

In the above embodiments, before identifying whether the task state is the task-ended state based on the actual execution duration of the task and the single task execution duration, the execution state that represents whether execution of the task is completed is obtained first, and the task state is determined based on the execution state, which can enrich the manners for identifying the task state. Further, the task state of the current task can be directly monitored as the task-ended state when the execution state is the task-completed state, thus the task state may be determined in time, and the service switching may be performed in time based on the current time point.

In S207, if the task state of the current task is the task-ended state, the service processing server determines a first service identifier of a first service corresponding to a current time point based on preset service mapping information.

In some embodiments, in a case where the task state of the current task is the task-ended state, the service processing server may re-determine a currently runnable service based on the current time point, and then corresponding tasks may be executed based on the task prompt information of the currently runnable service.

In some embodiments, the preset service mapping information may represent mapping relationship between multiple services and preset service running durations. In some embodiments of the disclosure, multiple may be at least two. In some embodiments, the multiple services include service A and service B, and a preset running duration corresponding to service A includes a duration from 0:00 on Feb. 1, 2021 to 24:00 on Feb. 13, 2021 and a duration from 0:00 on Feb. 14, 2021 to 24:00 on Feb. 20, 2021. A preset running duration corresponding to service B includes a duration from 0:00 on Feb. 14, 2021 to 24:00 on Feb. 14, 2021. A start time of a live streaming of a certain live streaming room is 23:40 on Feb. 13, 2021. In some embodiments, task prompt information of service A is issued as soon as the live streaming starts. Correspondingly, an execution starting time of a task is also 23:40 on Feb. 13, 2021. In some embodiments, assuming that a single task execution duration is 30 minutes, the task state is the task-ended state at 24:10 on Feb. 14, 2021, because the actual execution duration of the task reaches the single task execution duration. Correspondingly, the first service identifier of the first service corresponding to the current time point may be determined as the service identifier of service A based on the current time point 24:10 on Feb. 14, 2021.

In some embodiments, if the task state of the current task is monitored to be the task-ended state, the above-mentioned method may further include the following.

The service processing server sends a task execution result of the current task to a message queue.

The resource distribution server distributes a virtual resource corresponding to the current task to the terminal based on the task execution result after the resource distribution server monitors the task execution result.

In some embodiments, the above-mentioned task execution result may include a second service identifier (a service identifier of a second service) and execution progress information of the current task. In some embodiments, the execution progress information may represent the completion state of the task. In some embodiments, in the above-mentioned Spring Festival event scenario, the execution progress information may be the number of received blessings. In some embodiments, if the number of the received blessings reaches the preset number threshold, that is, is the task is completed, corresponding reward (virtual resource) may be issued based on the second service identifier. If the number of the received blessings does not reach the preset number threshold, that is, if the task is not completed, virtual resources may not be issued. In some embodiments, for cumulative tasks, if the task is not completed, the task execution result may be stored in the storage device, so that the task can continue to be completed when the preset service running duration of the second service is re-entered next time.

In the above embodiments, when the task ends, the task execution result of the current task is sent to the message queue, so that the resource distribution server performs subsequent virtual resource distribution control based on the message queue, which can effectively reduce the resource distribution pressure of the entire system, and improve the speed and reliability of virtual resource distribution while improving the operation fluency of the services in the system.

In some embodiments, the above-mentioned method may further include the following.

If the task data is not found, the service processing server performs the action of determining the first service identifier of the first service corresponding to the current time point based on the preset service mapping information.

In some embodiments of the disclosure, if the task data is not found, that is, the target live streaming room is not configured with a corresponding task, a task of a service may be initialized based on the current time point.

In the above embodiments, in the case where the task data is not found, the corresponding service can be determined based on the current time point, and execution of the corresponding task can be performed in time.

In S209, the service processing server sends task prompt information corresponding to the first service to a terminal corresponding to the target live streaming room based on the first service identifier.

In practical applications, the tasks corresponding to different services are often different, and accordingly, the task prompt information corresponding to different services are often different. In some embodiments of the disclosure, corresponding task prompt information may be pre-configured for different services, and the mapping relationship between the task prompt information and service identifiers is established. Correspondingly, the task prompt information may be determined based on a corresponding service identifier.

In some embodiments, the task prompt information corresponding to a service may be used to prompt a user to perform the task corresponding to the service, and the task prompt information may be set according to actual application requirements. In some embodiments, the task prompt information may include a task execution duration (in some embodiments, it can be displayed in a countdown manner), task content (for example, helping the anchor gather confession balloon), task progress information, and the like.

In some embodiments, as illustrated in FIG. 3, the action that the service processing server sends the task prompt information corresponding to the first service to the terminal corresponding to the target live streaming room based on the first service identifier may include the following.

In S2091, the task prompt information corresponding to the first service is determined based on the first service identifier.

In S2093, the task prompt information is sent to the terminal corresponding to the target live streaming room.

In some embodiments, that the service processing server sends the task prompt information to the terminal corresponding to the target live streaming room may include the following. The service processing server calls a preset remote delivery service. The service processing server sends the task prompt information to the terminal based on the preset remote delivery service.

In some embodiments, the preset remote delivery service may be a preset service for delivering task prompt information.

In the above embodiments, the task prompt information is delivered to the terminal through preset remote delivery service, which can improve the scalability and maintainability of the service processing server, with high availability.

In some embodiments, after the service processing server determines the first service identifier of the first service corresponding to the current time point based on the preset service mapping information, the above method may further include the following.

Task data of a task corresponding to the first service is generated based on the first service identifier.

The task data of the task corresponding to the first service is sent to the storage device to update the task data of the current task corresponding to the target live streaming room in the storage device.

In the above embodiments, when the current running service may be updated based on the current time point, the task data corresponding to the current service is updated to the storage device in time, so that the task data corresponding to each target live streaming room can be updated in time, which can provide data support for subsequent service update.

In S211, the terminal displays the task prompt information in the target live streaming room.

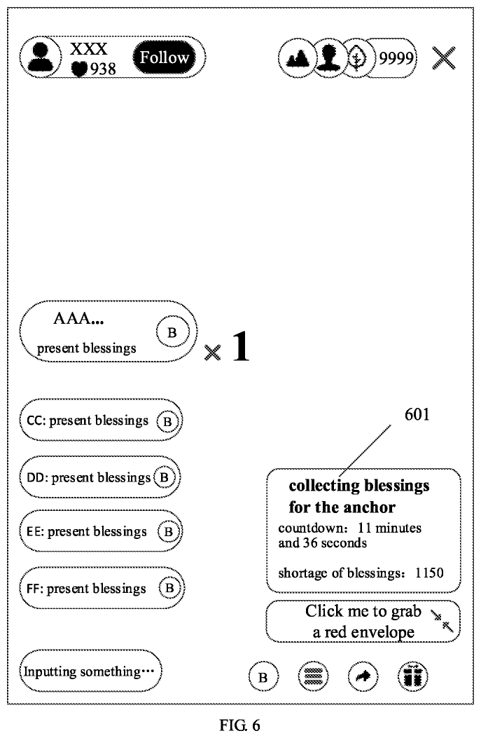

In some embodiments, for example, the target live streaming room is a live streaming room in an on-air state, and the terminal is an audience terminal. The first service determined based on the current time point is a Valentine's Day event, and the task corresponding to the Valentine's Day event is to present confession balloons (virtual items) to the anchor side from the audience side in the live streaming room. As illustrated in FIG. 6, FIG. 6 is a schematic diagram of a terminal page displaying task prompt information according to an exemplary embodiment. In detail, the task prompt information 601 includes collecting blessings for the anchor (task content), a countdown of 11 minutes and 36 seconds (execution duration), and a shortage of 1150 blessings (task progress information).

In some embodiments, when the task prompt information is issued, the relevant information required to perform the task, such as a blessing control 602 used to trigger the task execution in FIG. 6, can be issued according to actual task requirements, so that a user at the terminal side can perform corresponding tasks after the presentation on the terminal. In some embodiments, for a task whose task execution can be directly triggered based on the task prompt information, the task prompt information alone may be issued.

In some embodiments, the user at the terminal side may trigger the execution of the task corresponding to the first service according to the task prompt information.

In some embodiments of the disclosure, the execution starting time point of the above-mentioned current task is within a preset service running duration of a second service corresponding to the current task. In some embodiments, when the current time point is within the service running duration of the second service, the second service is the same service as the first service. Accordingly, a second service identifier of the second service corresponding to the current time point may be determined based on the preset service mapping information. Thus, based on the technical solution provided in embodiments of the disclosure, the second service may be further executed, and the tasks corresponding to the second service may be restarted.

In some embodiments, determining the first service identifier of the first service corresponding to the current time point based on the preset service mapping information may include the following. If the current time point is not within the preset service running duration of the second service, the first service identifier of the first service corresponding to the current time point is determined based on the preset service mapping information.

When the current time point is not within the service running duration of the second service, the second service and the first service are different services. Correspondingly, based on the technical solution provided in embodiments of the disclosure, the currently running service may be switched from the second service to the first service, and the task corresponding to the first service may be started.

As can be seen from the technical solutions provided in the above embodiments of the disclosure, by querying the task data of the current task corresponding to the target live streaming room, it can be determined whether the target live streaming room has a task currently being executed. If the task data is found, the task state of the current task may be monitored. When the task state is the task-ended state, the service to be currently executed may be determined based on the preset service mapping information that is capable to represent the mapping relationship between multiple services and their corresponding preset service running durations, and the task prompt information corresponding to the service is delivered to the terminal, so that the terminal may execute the corresponding task based on the task prompt information. Thus, multiple services may be flexibly and smoothly switched in each target live streaming room. When a new service is launched, it can also be smoothly transitioned to the newly launched service after the tasks of the previous service is completed, ensuring the continuity of the service in each target live streaming room, thereby greatly improving the interaction effect and the amount of visits within the platform.

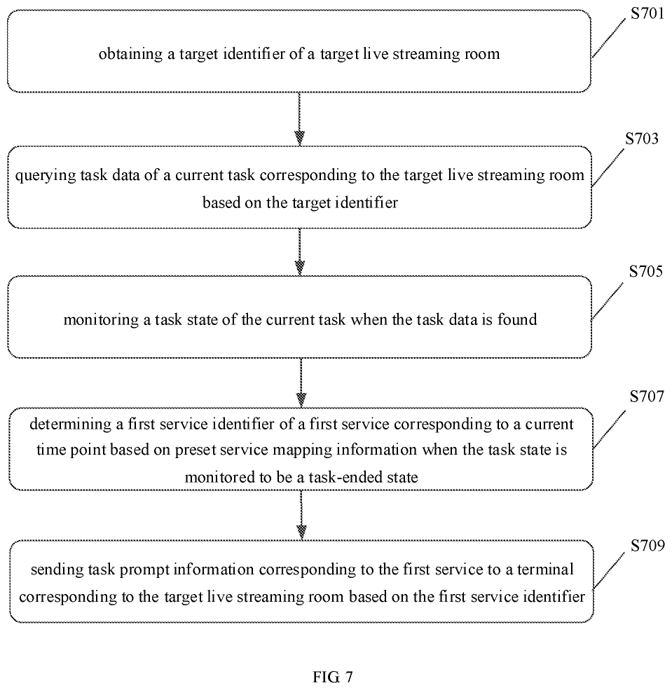

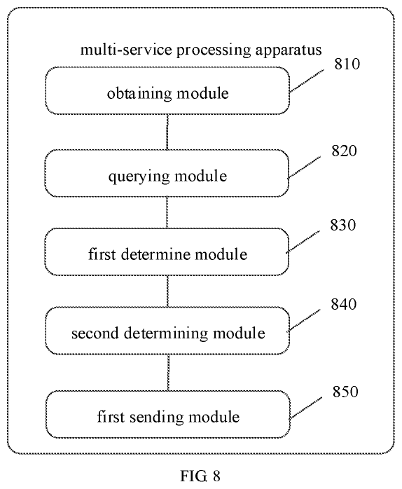

In the following, a service processing server is taken as an executive body to introduce the method for multi-service processing provided in the embodiments of the disclosure. In detail, as illustrated in FIG. 7, FIG. 7 is a flowchart of a method for multi-service processing according to an exemplary embodiment. In detail, the method may include the following.

In S701, a target identifier of a target live streaming room is obtained.

In S703, task data of a current task corresponding to the target live streaming room is queried based on the target identifier.

In S705, a task state of the current task is monitored when the task data is found.

In S707, a first service identifier of a first service corresponding to a current time point is determined based on preset service mapping information when the task state is monitored to be a task-ended state, the preset service mapping information representing mapping relationship between multiple services and preset service running durations.

In S709, task prompt information corresponding to the first service is sent to a terminal corresponding to the target live streaming room based on the first service identifier, so that the terminal displays the task prompt information in the target live streaming room.

In some embodiments, querying the task data of the current task corresponding to the target live streaming room based on the target identifier includes: querying the task data of the current task corresponding to the target live streaming room from a storage device based on the target identifier.

In some embodiments, after determining the first service identifier of the first service corresponding to the current time point based on the preset service mapping information, the method further includes: generating task data of a task corresponding to the first service based on the first service identifier; and sending the task data of the task corresponding to the first service to the storage device to update the task data of the current task corresponding to the target live streaming room in the storage device.

In some embodiments, monitoring the task state of the current task includes: obtaining a single task execution duration corresponding to the current task; determining a time difference between the current time point and an execution starting time point of the current task; and determining the task state of the current task as the task-ended state in response to the time difference reaches to the single task execution duration.

In some embodiments, before obtaining the single task execution duration corresponding to the current task, monitoring the task state of the current task further includes: obtaining an execution state of the current task; and performing the action of obtaining the single task execution duration corresponding to the current task in response to the execution state being a task-in-execution state.

In some embodiments, monitoring the task state of the current task further includes: determining the task state of the current task as the task-ended state in response to the execution state being a task-finished state.

In some embodiments, the method further includes: performing the action of determining the first service identifier of the first service corresponding to the current time point based on the preset service mapping information in response to no task data being queried.

In some embodiments, the method further includes: sending a task execution result of the current task to a message queue in response to the monitored task state being the task-ended state, to make a resource distribution server distribute a virtual resource corresponding to the current task to the terminal based on the task execution result after the resource distribution server monitors the task execution result.

In some embodiments, the target live streaming room includes a live streaming room in an on-air state. Obtaining the target identifier of the target live streaming room includes: sending an identifier obtaining request of the live streaming room in the on-air state to a live streaming server at a preset frequency; and receiving the target identifier of the live streaming room in the on-air state sent by the live streaming server.

In some embodiments, sending the task prompt information corresponding to the first service to the terminal corresponding to the target live streaming room based on the first service identifier includes: determining the task prompt information corresponding to the first service based on the first service identifier; and sending the task prompt information to the terminal corresponding to the target live streaming room.

In some embodiments, sending the task prompt information to the terminal corresponding to the target live streaming room includes: invoking a preset remote delivery service; and sending the task prompt information to the terminal based on the preset remote delivery service.

In some embodiments, an execution starting time point of the current task is within a preset service running duration of a second service corresponding to the current task. Determining the first service identifier of the first service corresponding to the current time point based on the preset service mapping information includes: determining the first service identifier of the first service corresponding to the current time point based on the preset service mapping information in response to the current time point is out of the preset service running duration of the second service.

In some embodiments, the method further includes: determining a second service identifier of a second service corresponding to the current time point based on the preset service mapping information in response to the current time point is within the preset service running duration of the second service.

With respect to the methods in the above embodiments, the specific manners for performing operations of each step have been described in detail in the foregoing embodiments regarding the interaction side methods, which will not be elaborated herein.

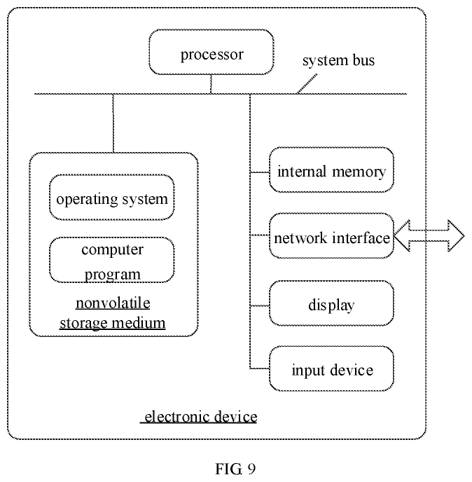

FIG. 8 is a block diagram illustrating an apparatus for multi-service processing according to some embodiments of the disclosure. As illustrated in FIG. 8, the apparatus includes an obtaining module 810, a querying module 820, a first determine module 830, a second determining module 840, and a first sending module 850.

The obtaining module 810 is configured to obtain a target identifier of a target live streaming room.

The querying module 820 is configured to query task data of a current task corresponding to the target live streaming room based on the target identifier.

The first determine module 830 is configured to monitor a task state of the current task in response to the queried task data.

The second determining module 840 is configured to determine a first service identifier of a first service corresponding to a current time point based on preset service mapping information in response to the monitored task state being a task-ended state, the preset service mapping information representing mapping relationship between multiple services and preset service running durations.

The first sending module 850 is configured to send task prompt information corresponding to the first service to a terminal corresponding to the target live streaming room based on the first service identifier, to make the terminal display the task prompt information in the target live streaming room.

In some embodiments, the querying module is configured to: query the task data of the current task corresponding to the target live streaming room from a storage device based on the target identifier.

In some embodiments, the apparatus further includes: a third determining module, configured to generate task data of a task corresponding to the first service based on the first service identifier; and a second sending module, configured to send the task data of the task corresponding to the first service to the storage device to update the task data of the current task corresponding to the target live streaming room in the storage device.

In some embodiments, the first determining module includes: a first obtaining unit, configured to obtain a single task execution duration corresponding to the current task; a monitoring unit, configured to determine a time difference between the current time point and an execution starting time point of the current task; and a first determining unit, configured to determine the task state of the current task as the task-ended state in response to the time difference reaches to the single task execution duration.

In some embodiments, the first determine module includes: a second obtaining unit, configured to obtain an execution state of the current task; the first determining unit is configured to perform the action of obtaining the single task execution duration corresponding to the current task in response to the execution state being a task-in-execution state.

In some embodiments, the first determining module includes: a second determining unit, configured to determine the task state of the current task as the task-ended state in response to the execution state being a task-finished state.

In some embodiments, the second determining module 840 is configured to perform the action of determining the first service identifier of the first service corresponding to the current time point based on the preset service mapping information in response to no task data being queried.

In some embodiments, the apparatus further includes: a third sending module, configured to send a task execution result of the current task to a message queue in response to the monitored task state being the task-ended state, to make a resource distribution server distribute a virtual resource corresponding to the current task to the terminal based on the task execution result after the resource distribution server monitors the task execution result.

In some embodiments, the target live streaming room includes a live streaming room in an on-air state, and the obtaining module 810 includes: a first sending unit, configured to send an identifier obtaining request of the live streaming room in the on-air state to a live streaming server at a preset frequency; and a receiving unit, configured to receive the target identifier of the live streaming room in the on-air state sent by the live streaming server.

In some embodiments, the first sending module 850 includes: a third determining unit, configured to determine the task prompt information corresponding to the first service based on the first service identifier; and a second sending unit, configured to send the task prompt information to the terminal corresponding to the target live streaming room.

In some embodiments, the second sending unit includes: an invoking unit, configured to invoke a preset remote delivery service; and a third sending unit, configure to send the task prompt information to the terminal based on the preset remote delivery service.

In some embodiments, an execution starting time point of the current task is within a preset service running duration of a second service corresponding to the current task, the second determining module 840 is configured to determine the first service identifier of the first service corresponding to the current time point based on the preset service mapping information in response to the current time point is out of the preset service running duration of the second service.

In some embodiments, the apparatus further includes: a fourth determining module, configured to determine a second service identifier of a second service corresponding to the current time point based on the preset service mapping information in response to the current time point is within the preset service running duration of the second service.

With respect to the system in the above embodiments, the specific manners for performing operations for individual modules therein have been described in detail in the embodiments regarding the methods, which will not be elaborated herein.

Embodiments of the disclosure further provide a multi-service processing system including: a service processing server and a terminal.

The service processing server is configured to: obtain a target identifier of a target live streaming room; query task data of a current task corresponding to the target live streaming room based on the target identifier; monitor a task state of the current task in response to the queried task data; determine a first service identifier of a first service corresponding to a current time point based on preset service mapping information in response to the monitored task state being a task-ended state, the preset service mapping information representing mapping relationship between multiple services and preset service running durations; and send task prompt information corresponding to the first service to the terminal corresponding to the target live streaming room based on the first service identifier.

The terminal is configured to display the task prompt information in the target live streaming room.

In some embodiments, the system further includes a storage device. The service processing server is configured to: generate task data of a task corresponding to the first service based on the first service identifier; and send the task data of the task corresponding to the first service to the storage device to update the task data of the current task corresponding to the target live streaming room in the storage device.

In some embodiments, the system further includes: a message queue and a resource distribution server.

The service processing server is configured to send a task execution result of the current task to the message queue in response to the monitored task state being the task-ended state.

The resource distribution server is configured to distribute a virtual resource corresponding to the current task to the terminal based on the task execution result after the resource distribution server monitors the task execution result.

In some embodiments, the target live streaming room includes a live streaming room in an on-air state. The system further includes a live streaming server. The service processing server is configured to: send an identifier obtaining request of the live streaming room in the on-air state to the live streaming server at a preset frequency; and receive the target identifier of the live streaming room in the on-air state sent by the live streaming server.

The live streaming server is configured to send the target identifier of the live streaming room in the on-air state to the service processing server.

With respect to the system in the above embodiments, the specific manners for performing operations for the system have been described in detail in the embodiments regarding the methods, which will not be elaborated herein.

FIG. 9 is a schematic diagram illustrating an electronic device for multi-service processing according to some embodiments of the disclosure. The electronic device may be a server. The internal structure diagram may be as illustrated in FIG. 9. The electronic device includes a processor, a memory and a network interface connected through a system bus. The processor of the electronic device is configured to provide calculation and control capabilities. The memory of the electronic device includes a nonvolatile storage medium and an internal memory. The nonvolatile storage medium stores an operating system and a computer program. The internal memory provides an environment for operations of the operating system and computer program in the nonvolatile storage medium. The network interface of the electronic device is configured to communicate with an external terminal through a network connection. The computer program is executed by the processor to realize the method for multi-service processing.

Those skilled in the art may understand that the structure in FIG. 9 is only a block diagram of a part of the structure related to the solutions of the disclosure and may not constitute a limitation on the electronic device to which the solutions of the disclosure is applied. The specific electronic device may include more or less parts than shown in the figure or combine some parts or has a different arrangement of parts.

In some embodiments, an electronic device is also provided, including: a processor; and a memory for storing instructions executable by the processor. The processor is configured to execute the instructions to perform the method for multi-service processing in the embodiments of the disclosure.

In some embodiments, a computer-readable storage medium is also provided. When instructions in the storage medium are executed by the processor of the electronic device, the electronic device may be caused to perform the method for multi-service processing in the embodiments of the disclosure.

In some embodiments, a computer program product containing instructions is also provided. When the computer program product runs on a computer, the computer may be caused to perform the method for multi-service processing in the embodiments of the disclosure.

Those skilled in the art may understand that all or part of processes in the above-mentioned embodiment methods may be implemented by instructing relevant hardware through a computer program. The computer program may be stored in a nonvolatile computer-readable storage medium. When the computer program is executed, it may include procedures of the above-mentioned method embodiments. Any reference to the memory, storage, database or other media used in the embodiments provided in the disclosure may include a nonvolatile and/or volatile memory. The nonvolatile memory may include a read only memory (ROM), a programmable ROM (PROM), an electrically programmable ROM (EPROM), an electrically erasable programmable ROM (EEPROM) or a flash memory. The volatile memory may include a random access memory (RAM) or an external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), memory bus (Rambus) direct RAM (RDRAM), direct memory bus dynamic RAM (DRDRAM), memory bus dynamic RAM (RDRAM), etc.

Those skilled in the art will easily think of other embodiments of the disclosure after considering the specification and practicing the disclosure disclosed herein. The disclosure is intended to cover any variations, uses or adaptive changes of the disclosure. These variations, uses or adaptive changes follow the general principles of the disclosure and include common knowledge or conventional technical means in the technical field that are not disclosed in the disclosure. The description and the embodiments are to be regarded as exemplary only and the true scope and spirit of the disclosure are pointed out by the following claims.

It will be appreciated that the disclosure is not limited to the exact construction that has been described above and illustrated in the accompanying drawings, and that various modifications and changes may be made without departing from the scope thereof. It is intended that the scope of the disclosure only be limited by the appended claims.

What is claimed is:

1. A method for multi-service processing, comprising:
obtaining a target identifier of a target live streaming room;
querying task data of a current task corresponding to the target live streaming room based on the target identifier;
monitoring a task state of the current task in response to the queried task data;
determining a first service identifier of a first service corresponding to a current time point based on preset service mapping information in response to the monitored task state being a task-ended state, the preset service mapping information representing mapping relationship between multiple services and preset service running durations; and
sending task prompt information corresponding to the first service to a terminal corresponding to the target live streaming room based on the first service identifier, to make the terminal display the task prompt information in the target live streaming room.

2. The method as claimed in claim 1, wherein said querying the task data of the current task corresponding to the target live streaming room based on the target identifier comprises:
querying the task data of the current task corresponding to the target live streaming room from a storage device based on the target identifier.

3. The method as claimed in claim 2, further comprising:
generating task data of a task corresponding to the first service based on the first service identifier; and
sending the task data of the task corresponding to the first service to the storage device to update the task data of the current task corresponding to the target live streaming room in the storage device.

4. The method as claimed in claim 1, wherein said monitoring the task state of the current task comprises:
obtaining a single task execution duration corresponding to the current task;
determining a time difference between the current time point and an execution starting time point of the current task; and
determining the task state of the current task as the task-ended state in response to the time difference reaches to the single task execution duration.

5. The method as claimed in claim 4, wherein said monitoring the task state of the current task comprises:
obtaining an execution state of the current task; and
performing an action of obtaining the single task execution duration corresponding to the current task in response to the execution state being a task-in-execution state.

6. The method as claimed in claim 5, wherein said monitoring the task state of the current task comprises:
determining the task state of the current task as the task-ended state in response to the execution state being a task-finished state.

7. The method as claimed in claim 1, further comprising:
performing an action of determining the first service identifier of the first service corresponding to the current time point based on the preset service mapping information in response to no task data being queried.

8. The method as claimed in claim 1, further comprising:
sending a task execution result of the current task to a message queue in response to the monitored task state being the task-ended state, to make a resource distribution server distribute a virtual resource corresponding to the current task to the terminal based on the task execution result after the resource distribution server monitors the task execution result.

9. The method as claimed in claim 1, wherein the target live streaming room comprises a live streaming room in an on-air state, and said obtaining the target identifier of the target live streaming room comprises:
sending an identifier obtaining request of the live streaming room in the on-air state to a live streaming server at a preset frequency; and
receiving the target identifier of the live streaming room in the on-air state sent by the live streaming server.

10. The method as claimed in claim 1, wherein said sending the task prompt information corresponding to the first service to the terminal corresponding to the target live streaming room based on the first service identifier comprises:
determining the task prompt information corresponding to the first service based on the first service identifier; and
sending the task prompt information to the terminal corresponding to the target live streaming room.

11. The method as claimed in claim 10, wherein said sending the task prompt information to the terminal corresponding to the target live streaming room comprises:
invoking a preset remote delivery service; and
sending the task prompt information to the terminal based on the preset remote delivery service.

12. The method as claimed in claim 1, wherein an execution starting time point of the current task is within a preset service running duration of a second service corresponding to the current task, and said determining the first service identifier of the first service corresponding to the current time point based on the preset service mapping information comprises:
determining the first service identifier of the first service corresponding to the current time point based on the preset service mapping information in response to the current time point is out of the preset service running duration of the second service.

13. The method as claimed in claim 12, further comprising:
determining a second service identifier of a second service corresponding to the current time point based on the preset service mapping information in response to the current time point is within the preset service running duration of the second service.

14. A system for multi-service processing system, comprising:
a service processing server and a terminal;
the service processing server is configured to: obtain a target identifier of a target live streaming room; query task data of a current task corresponding to the target live streaming room based on the target identifier; monitor a task state of the current task in response to the queried task data; determine a first service identifier of a first service corresponding to a current time point based on preset service mapping information in response to the monitored task state being a task-ended state, the preset service mapping information representing mapping relationship between multiple services and preset service running durations; and send task prompt information corresponding to the first service to the terminal corresponding to the target live streaming room based on the first service identifier;
the terminal is configured to display the task prompt information in the target live streaming room.

15. The system as claimed in claim 14, wherein the system further comprises a storage device,
the service processing server is configured to: generate task data of a task corresponding to the first service based on the first service identifier; and send the task data of the task corresponding to the first service to the storage device to update the task data of the current task corresponding to the target live streaming room in the storage device.

16. The system as claimed in claim 14, wherein the system further comprises: a message queue and a resource distribution server;
the service processing server is further configured to send a task execution result of the current task to the message queue in response to the monitored task state being the task-ended state;
the resource distribution server is configured to distribute a virtual resource corresponding to the current task to the terminal based on the task execution result after the resource distribution server monitors the task execution result.

17. The system as claimed in claim 14, wherein the target live streaming room comprises a live streaming room in an on-air state, the system further comprises a live streaming server;
the service processing server is configured to: send an identifier obtaining request of the live streaming room in the on-air state to the live streaming server at a preset frequency;
the live streaming server is configured to send the target identifier of the live streaming room in the on-air state to the service processing server.

18. An electronic device, comprising:
a processor; and
a memory for storing instructions executable by the processor;
wherein the processor is configured to execute the instructions to:
obtain a target identifier of a target live streaming room;
query task data of a current task corresponding to the target live streaming room based on the target identifier;
monitor a task state of the current task in response to the queried task data;
determine a first service identifier of a first service corresponding to a current time point based on preset service mapping information in response to the monitored task state being a task-ended state, the preset service mapping information representing mapping relationship between multiple services and preset service running durations; and
send task prompt information corresponding to the first service to a terminal corresponding to the target live streaming room based on the first service identifier, to make the terminal display the task prompt information in the target live streaming room.

19. The electronic device as claimed in claim 18, wherein the processor is configured to execute the instructions to:
query the task data of the current task corresponding to the target live streaming room from a storage device based on the target identifier.

20. The electronic device as claimed in claim 19, wherein the processor is configured to execute the instructions to:
generate task data of a task corresponding to the first service based on the first service identifier; and
send the task data of the task corresponding to the first service to the storage device to update the task data of the current task corresponding to the target live streaming room in the storage device.
